(19) United States
(12) Patent Application Publication
(10) Pub. No.: US 2012/0281100 A1
(43) Pub. Date: Nov. 8, 2012

(54) CONTROL SYSTEM AND METHOD FOR A COMPUTER USING A PROJECTOR

(75) Inventors: JIE-JUN TAN, Shenzhen City (CN); YI-YONG XIE, Shenzhen City (CN); YU-LONG LIN, Shenzhen City (CN); HUA DONG, Shenzhen City (CN)

(73) Assignees: HON HAI PRECISION INDUSTRY CO., LTD., Tu-Cheng (CN); HONG FU JIN PRECISION INDUSTRY (ShenZhen) CO., LTD, Shenzhen City (CN)

(21) Appl. No.: 13/451,414

(22) Filed: Apr. 19, 2012

(30) Foreign Application Priority Data
May 6, 2011 (CN) 201110117009.7

(51) Int. Cl. H04N 5/225

(52) U.S. Cl. 348/207.1; 348/E05.024

(57) ABSTRACT

A computer and method executes an operation when a user places an object between a projector and a projection screen, wherein the computer is connected to the projector. The computer captures an image of the projection screen. Furthermore, the computer obtains coordinates of each pixel of an shape of a shadow of an object and calculates average coordinates of the shape of the shadow of the object, in response to a determination that the shape of the shadow of the object matches the predetermined shape. The computer executes an operation on the average coordinates of the shape of the shadow of the object.

### BACKGROUND

1. Technical Field

Embodiments of the present disclosure relate to projector technology, and particularly to a control system and method for a computer using a projector.

2. Description of Related Art

Projectors are devices which project images onto a screen. Projectors are often used to make presentations. A user may press a key on a keyboard of a computer or use a laser pointer to change a slide when addressing his/her audience. However, if the user has no laser pointer, or is some distance away from the keyboard, or is in the dark, it is not convenient to change the slide. Further and better methods are desirable.

### BRIEF DESCRIPTION OF THE DRAWINGS

FIG. 1 is a system view of one embodiment of a control system.

FIG. 2 is a block diagram of one embodiment of a computer of FIG. 1.

FIG. 3 is a flowchart of one embodiment of a control method.

FIG. 4 illustrates one embodiment of a projection screen, a projection area of the projection screen, and a shape of an object superimposed on a projected image, the object being positioned between the projection screen and the projector.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

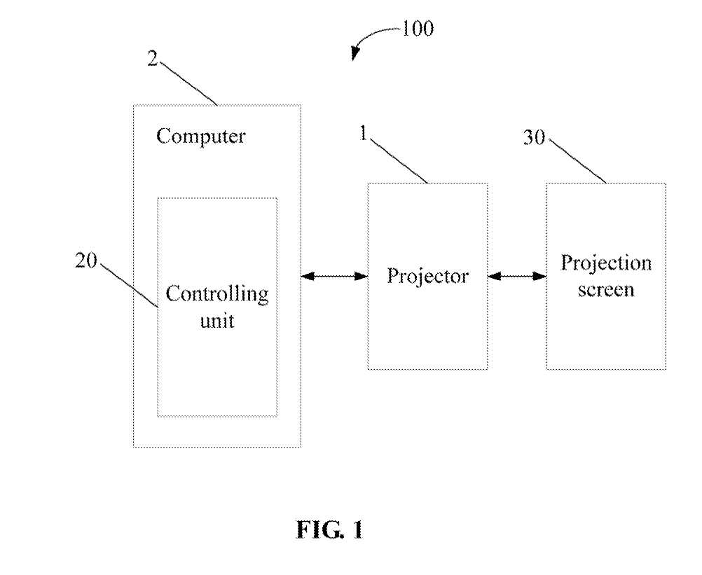

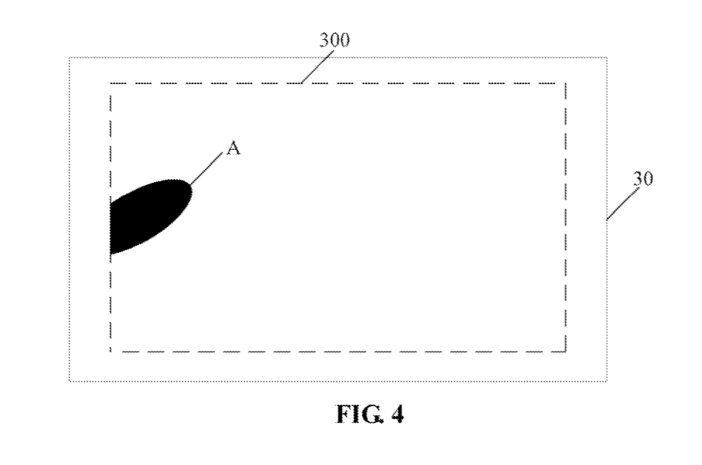

FIG. 1 is a system view of one embodiment of a control system 100. In one embodiment, the control system 100 may include a projector 1 and a computer 2. The computer 2 is electronically connected to the projector 1. The projector 1 includes a projection screen 30. The projection screen 30 includes a projection area 300, as shown in FIG. 4. The projector 10 projects images, slides or videos on the projection area 300 when the images, slides or videos are played by the computer 2. The projector 1 may be, but is not limited to, a digital light processing (DLP) projector. The control system 100 may be used to control the computer 2 by an object (e.g., a finger of a user) which is positioned between the projector 1 and the projection screen 30.

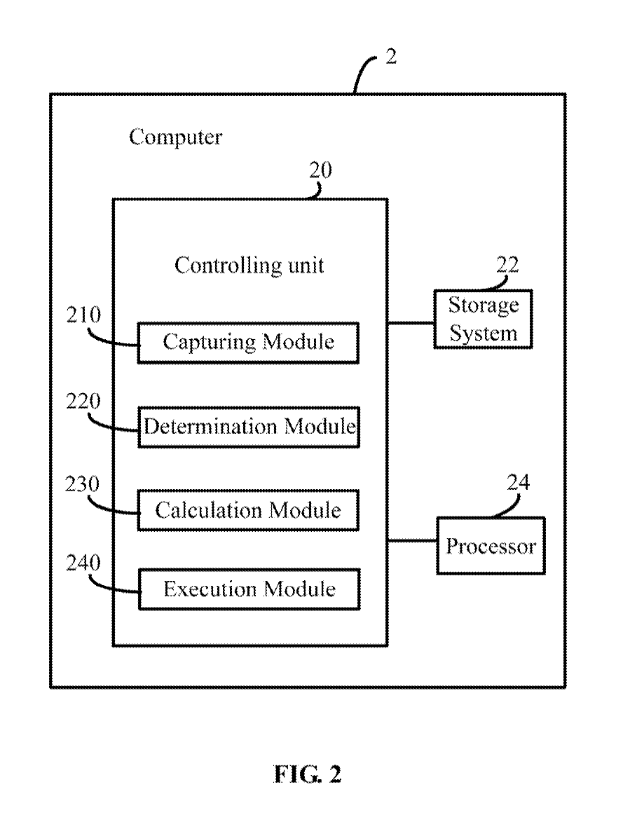

FIG. 2 is a block diagram of one embodiment of the computer 2 including a control unit 20. The control unit 20 may be used to control one or more operations of the computer 2 when a user puts the object in front of the projector 1. The one or more operations may be, but are not limited to, a double click and a single click. In one embodiment, the computer 2 includes a storage system 22, and at least one processor 24. The control unit 20 includes a capturing module 210, a determination module 220, a calculation module 230, and an execution module 240. The modules 210-240 may include computerized code in the form of one or more programs that are stored in a storage system 22. The computerized code includes instructions that are executed by the at least one processor 24 to provide functions for modules 210-240. The storage system 22 may be a cache, a dedicated memory, flash or a hard drive.

The capturing module 210 captures an image of the projection screen 30. In one embodiment, the image is captured by a camera of the projector 1. The image of the projection screen 30 includes a shape of the shadow of the object. The object is positioned between the projector 1 and the projection screen 30.

The determination module 220 determines if the shape of the shadow of the object matches a predetermined shape. The shape of the shadow of the object is generated when the object is positioned between the projector 1 and the projection screen 30. As shown in FIG. 4, the shape of the shadow of the object is the black area A. The predetermined shape is substantially in the shape of a finger. In one embodiment, as shown in FIG. 4, the determination module 220 determines if the black area A matches the shape of the finger.

The obtaining module 230 obtains coordinates of each pixel of the shape of the shadow of the object and calculates average coordinates of the shape of the shadow of the object, in response to a determination that the shape of the shadow of the object matches the predetermined shape. As shown in FIG. 4, the obtaining module 230 obtains coordinates of each pixel of the black area A and calculates average coordinates of the black area A according to the coordinates of each pixel of the black area A.

The execution module 240 executes an operation of the computer 2 according to the average coordinates of the shape of the shadow of the object. For example, the execution module 240 may execute a computer function, such as a double click or a single click, on the average coordinates of the shape of the shadow of the object. If an operation system installed in the computer 2 is MICROSOFT WINDOWS, a command corresponding to the single click is WM_LBUTTONDOWN, and a command corresponding to the double click is WM_LBUTTONDBLCLK. The execution module 240 invokes WM_LBUTTONDOWN to execute the single click, and invokes WM_LBUTTONDBLCLK to execute the double click. Additionally, the execution module 240 also obtains a time duration for the shape of the shadow of the object staying in the projection screen 30, the execution module 240 executes the operation according to the time duration. For example, if the time duration is greater than two seconds and less than three seconds, the execution module 240 executes the single click on the average coordinates of the shape of the shadow of the object. If the time duration is equal to or greater than three second, the execution module 240 executes the double click on the average coordinates of the shape of the shadow of the object.

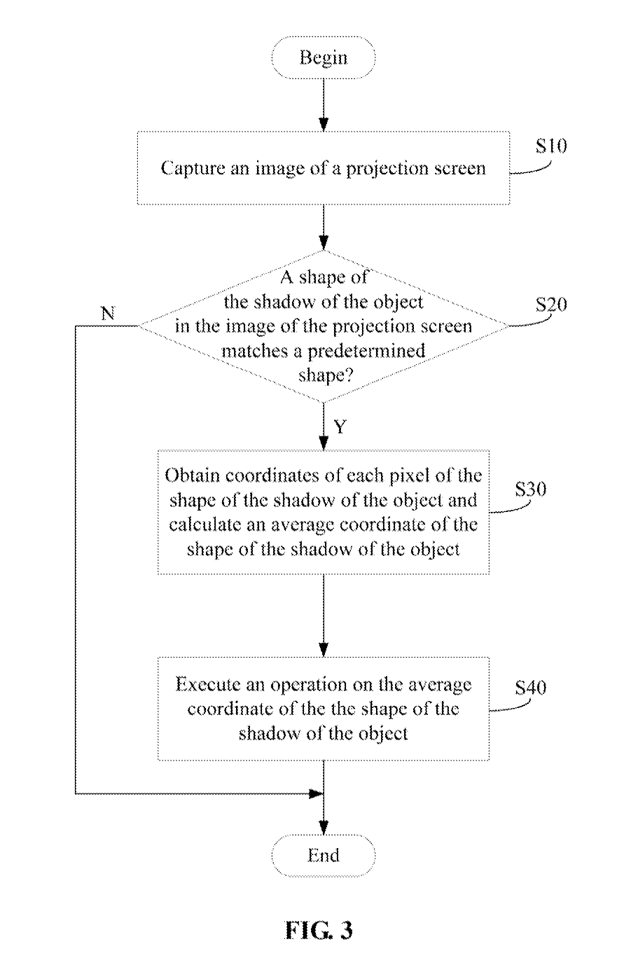

FIG. 3 is a flowchart of one embodiment of a control method. Depending on the embodiment, additional blocks may be added, others deleted, and the ordering of the blocks may be changed.

In step S10, the capturing module 210 captures an image of the projection screen 30. In one embodiment, the image may include a shape of the shadow of the object. As shown in FIG. 4, the black area represents the shape of the shadow of the object superimposed onto the projection area 300. The object may be, but is not limited to, a finger of the user.

In step S20, the determination module 220 determines if the shape of the shadow of the object matches a predetermined shape. As shown in FIG. 4, if the black area A substantially matches the shape of the finger, the procedure goes to step S30. Otherwise, if the black area does not match the shape of the finger, the procedure ends.

In step S30, the obtaining module 230 obtains coordinates of each pixel of the shape of the shadow of the object and calculates average coordinates of the shape of the shadow of the object. For example, if the black area A includes five pixels, the coordinates of the five pixels are P1, P2, P3, P4 and P5, the average coordinates of the five pixels is equal to (P1+P2+P3+P4+P5)/5.

In step S40, the execution module 240 executes an operation of the computer 2 according to the average coordinates of the shape of the shadow of the object. Additionally, the execution module 240 executes an operation on the average coordinates of the shape of the shadow of the object based on a time duration that the shape of the shadow of the object stays in the projection screen 30. For example, if the time duration is greater than two seconds and less than three seconds, the execution module 240 executes the single click on the average coordinates of the shape of the shadow of the object. If the time duration is equal to or greater than three second, the execution module 240 executes the double click on the average coordinates of the shape of the shadow of the object.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, the computer in electronic communication with a projector, comprising:
a storage system;
at least one processor; and
one or more programs stored in the storage system and being executable by the at least one processor, the one or more programs comprising:
a capturing module that captures an image of a projection screen of the projector, wherein the image of the projection screen comprises a shape of a shadow of an object, and the object is positioned between the projector and the projection screen;
a determination module that determines if the shape of the shadow of the object matches a predetermined shape;
an obtaining module that obtains coordinates of each pixel of the shape of the shadow of the object, and calculates average coordinates of the shape of the shadow of the object, in response to a determination that the shape of the shadow of the object matches the predetermined shape; and
an execution module that executes an operation of the computer according to the average coordinates of the shape of the shadow of the object.

2. The computer of claim 1, wherein the object is a finger of a user.

3. The computer of claim 1, wherein the shape of the shadow of the object is generated when the object is positioned between the projector and the projection screen.

4. The computer of claim 1, wherein the predetermined shape is a finger shape.

5. The computer of claim 1, wherein the operation is a double click or a single click.

6. The computer of claim 1, wherein the execution module further obtains a time duration that the shape of the shadow of the object stays in the projection screen and executes the operation according to the time duration.

7. A control method implemented by a computer, the computer in electronic communication with a projector, the method comprising:
capturing an image of a projection screen of the projector, wherein the image of the projection screen comprises a shape of a shadow of an object, and the object is positioned between the projector and the projection screen;
determining if the shape of the shadow of the object matches a predetermined shape;
obtaining coordinates of each pixel of the shape of the shadow of the object, and calculating average coordinates of the shape of the shadow of the object, in response to a determination that the shape of the shadow of the object matches the predetermined shape; and
executing an operation of the computer according to the average coordinates of the shape of the shadow of the object.

8. The method of claim 7, wherein the object is a finger of a user.

9. The method of claim 7, wherein the shape of the shadow of the object is generated when the object is positioned between the projector and the projection screen.

10. The method of claim 7, wherein the predetermined shape is a finger shape.

11. The method of claim 7, wherein the operation is a double click or a single click.

12. The method of claim 7, further comprising:
obtaining a time duration for the shape of the shadow of the object staying in the projection screen and executing the operation according to the time duration.

13. A non-transitory computer-readable medium having stored thereon instructions that, when executed by a computer, the computer in electronic communication with a projector, causing the computer to perform a control method, the method comprising:
capturing an image of a projection screen of the projector, wherein the image of the projection screen comprises a shape of a shadow of an object, and the object is positioned between the projector and the projection screen;
determining if the shape of the shadow of the object matches a predetermined shape;
obtaining coordinates of each pixel of the shape of the shadow of the object, and calculating average coordinates of the shape of the shadow of the object, in response to a determination that the shape of the shadow of the object matches the predetermined shape; and
executing an operation of the computer according to the average coordinates of the shape of the shadow of the object.

14. The medium of claim 13, wherein the object is a finger of a user.

15. The medium of claim 13, wherein the shape of the shadow of the object is generated when the object is positioned between the projector and the projection screen.

16. The medium of claim 13, wherein the predetermined shape is a finger shape.

17. The medium of claim 13, wherein the operation is a double click or a single click

18. The medium of claim 13, the method further comprises:
obtaining a time duration for the shape of the shadow of the object staying in the projection screen and executing the operation according to the time duration.
